(19) United States
(12) Patent Application Publication
(10) Pub. No.: US 2025/0214241 A1
(43) Pub. Date: Jul. 3, 2025

(54) CONTROL DEVICE AND METHOD FOR CONTROLLING A ROBOTIC DEVICE FOR PACKING AND/OR UNPACKING A STORAGE BOX

(71) Applicant: Intel Corporation, Santa Clara, CA (US)

(72) Inventors: Cornelius BUERKLE, Karlsruhe (DE); Frederik PASCH, Karlsruhe (DE); Fabian OBORIL, Karlsruhe (DE); Qutub SYED SHA, Munich (DE)

(21) Appl. No.: 18/956,024

(22) Filed: Nov. 22, 2024

(30) Foreign Application Priority Data
Dec. 28, 2023 (DE) 10 2023 136 752.8

(51) Int. Cl. B25J 9/16; B25J 19/02

(52) U.S. Cl. CPC B25J 9/1679; B25J 9/161; B25J 9/1661; B25J 19/023

(57) ABSTRACT

A control device includes a memory device storing, for each storage box of a plurality of storage boxes, respectively associated first box information indicating which multiple objects are arranged in the storage box and in which arrangement the multiple objects are in the storage box; and a processor configured to: receive identification data representing an identification of a storage box; determine the first box information associated with the storage box using the identification data; receive sensor data representing an image of the multiple objects arranged in the storage box; determine, via object recognition using the sensor data, second box information indicating which objects are arranged in the storage box; generate control instructions for controlling the robotic device to pick up at least one object of the multiple objects based on the first box information associated with the storage box and the second box information.

### CROSS-REFERENCE TO RELATED APPLICATIONS

This application claims priority to German patent application 10 2023 136 752.8, filed on Dec. 28, 2023, the entire contents of which are incorporated herein by reference.

### TECHNICAL AREA

Various aspects of this disclosure relate in general to a control device and a method for controlling a robotic device for entirely or partially unpacking or picking objects from a storage box.

### BACKGROUND

Objects (such as products) can be stored for storage in storage boxes and picked from the storage boxes again at a later time (for example when the objects are to be shipped) in warehouses (also referred to as depots). A robot can be used to pick the objects from a storage box. In order that the robots can pick the objects it is necessary for the objects to be correctly recognized and identified in order to determine how the robot can reach the objects, in which order the robot can pick the objects, and how it can grip the respective object. This problem is also referred to as a part picking problem (bin picking).

### BRIEF DESCRIPTION OF THE DISCLOSURE

According to various embodiments, a control device and a method for controlling a robotic device for entirely or partially unpacking or picking objects from a storage box are provided, which enable improved recognition and gripping of objects in a storage box. For example, a classification rate at which objects are correctly classified (thus recognized) is increased. According to various aspects, the recognition and gripping of objects is improved by acquiring information with respect to the objects in a storage box during the packing of the storage box and using this information during the unpacking or gripping.

### BRIEF DESCRIPTION OF THE FIGURES

In the drawings, reference signs in the various views generally relate to the same parts. The drawings are not necessarily to scale, instead in general focus is placed on illustrating the principles of the invention. In the following description, various embodiments of the invention are described with reference to the following drawings, in the figures of which:

FIG. 1 shows an exemplary warehouse system according to various aspects.

FIG. 2 shows an exemplary unpacking station according to various aspects.

FIG. 3 and FIG. 4 each show a flow chart for picking at least one object from a storage box according to various aspects.

FIG. 5 shows an exemplary stack of multiple objects in a storage box according to various aspects.

FIG. 6 shows an exemplary image of multiple objects arranged in a storage box according to various aspects.

FIG. 7 shows a flow chart of a method for controlling a robotic device for picking at least one object from a storage box according to various aspects.

FIG. 8 shows a flow chart of a method for controlling a robotic device for packing a storage box according to various aspects.

### DETAILED DESCRIPTION

The following detailed description relates to the appended drawings which show specific details and embodiments for illustration, in which the invention can be embodied.

The word “exemplary” is used herein to mean “used as an example, case, or illustration”. Any embodiment described herein as “exemplary” is not necessarily to be considered preferred or advantageous in relation to other embodiments.

The terms “at least one” and “one or more” can be understood to mean that they comprise a numeric amount greater than or equal to one (e.g., one, two, three, four, [ . . . ] etc.). The term “a plurality” can be understood to mean that it comprises a numeric amount greater than or equal to two (e.g., two, three, four, five, [ . . . ] etc.).

The terms “multiple” and “plurality” expressly refer to an amount greater than one. Accordingly, all expressions which expressly refer to the above-mentioned words (for example, a plurality of elements, multiple elements) refer to a set of elements, expressly to more than one of these elements. The expressions “group (of)”, “set (of)”, “collection (of)”, “series (of)”, “sequence (of)”, “grouping (of)” etc. and similar expressions in the description and in the claims refer to an amount which is equal to or greater than one, thus one or more.

The expression “at least one of” with reference to a group of elements can be used here to mean at least one element from the group comprising the elements. For example, the expression “at least one of” in reference to a group of elements can be used here to mean a selection of: one of the listed elements, a plurality of one of the listed elements, a plurality of individual listed elements, or a plurality of a multiple of individual listed elements.

The term “data” used herein can be understood to mean that it comprises information in any suitable analog or digital form, e.g., in the form of a file, a part of a file, a set of files, a signal or flow, a part of a signal or flow, a set of signals or flows, and the like. In addition, the term “data” can also be used for a reference to information, for example, in the form of a pointer. The term “data” is not restricted to the above-mentioned examples, however, and can assume various forms and represent any arbitrary information as understood in the technical world.

The term “processor” as used herein can be understood as any type of entity that permits the processing of data or signals. The data or signals can be handled, for example, according to at least one (i.e. one or more than one) specific function executed by the processor. The processor can comprise or be formed from an analog circuit, a digital circuit, a mixed-signal circuit, a logic circuit, a microprocessor, a central processing unit (CPU), a graphics processing unit (GPU), a digital signal processor (DSP), a field-programmable gate arrangement (FPGA), an integrated circuit, or any combination thereof. Any other type of the implementation of the respective functions which are described in more detail hereinafter can also be understood as a processor or logic circuit. It is apparent that one or more of the method steps described herein in detail can be executed (for example, implemented) by a processor by one or more specific functions executed by the processor. The processor can therefore be configured to carry out one of the methods described herein or its components for information processing.

Differences between software-implemented and hardware-implemented data processing can blur. A processor, a security system, a computing system, and/or other aspects described herein can be implemented in software, hardware, and/or as a hybrid implementation with both software and hardware.

The term “memory” is understood here as a computer-readable medium in which data or information can be stored for retrieval. A memory used in the embodiments can be a volatile memory, such as a DRAM (dynamic random access memory), or a nonvolatile memory, such as a PROM (programmable read-only memory), an EPROM (erasable PROM), an EEPROM (electrically erasable PROM), or a flash memory, such as a floating-gate memory device, a charge-absorbing memory device, a MRAM (magnetoresistive random access memory), or a PCRAM (phase-change random access memory). A memory can be a flash memory, a solid-state memory, a magnetic tape, a hard drive, an optical drive, etc. or any combination thereof. Registers, shift registers, process registers, data buffers, etc. also fall under the concept of “memory”. The term “software” relates to all types of executable commands, including firmware.

The term “system” (e.g., a computing system, a warehouse system, etc.), which will be discussed in more detail here, can be understood as a set of interacting elements, wherein the elements can be, by way of example and not restrictively, one or more mechanical components, one or more electrical components, one or more instructions (for example, coded in storage media), and/or one or more processors and the like.

The term “actuator” can be understood as a component which is capable of influencing a mechanism as a reaction to being driven. The actuator can convert instructions output by a control device (the so-called activation) into mechanical movements. The actuator, for example, an electromechanical transducer, can be configured to convert electrical energy as a reaction to its actuation into mechanical energy.

If not expressly indicated, the term “transmit” includes both direct (point-to-point) and also indirect transmission (via one or more intermediate points). In a similar manner, the term “receive” includes both direct and indirect reception. In addition, the terms “transmit”, “receive”, “communicate”, and similar terms comprise both physical transmission (for example, the transmission of radio signals) and logical transmission (for example, the transmission of digital data via a logic connection on the software level). For example, a processor or a control device can transmit or receive data via a connection on the software level to another processor or another control unit in the form of radio signals, wherein the physical transmission and the reception are handled by components of the radio layer such as HF transceivers and antennas and the logical transmission and the reception are carried out via the connection on the software level by the processors or control devices. The term “communicate” comprises both transmitting and receiving, i.e. unidirectional or bidirectional communication in one or both directions, i.e. incoming and outgoing.

The term “calculate” comprises both “direct” calculations by means of a mathematical expression/a formula/a relationship and “indirect” calculations by means of lookup tables or hash tables and other array indexing or search operations.

A model (for example, a model based on machine learning (also referred to as a machine learning model)) can comprise or be, for example, a reinforcement learning model (e.g., using Q learning, temporal difference (TD), deep adversarial networks, etc.) and/or a classification model (e.g., a linear classifier (for example, a logistical regression classifier or a naïve Bayes classifier), a support vector machine, a decision tree, a boosted tree classifier, a random forest classifier, a neural network, or a nearest neighbor model. A neural network can be or comprise any type of neural network, for example, a convolutional neural network (CNN), a variational autoencoder network (VAE), a sparse autoencoder network (SAE), a recurrent neural network (RNN), a deconvolutional neural network (DNN), a generative adversarial network (GAN), a forward-thinking neural network, a sum-product neural network, a transformer-based network, etc.

A “control device” as used herein can be understood as any type of entity (for example, implementing logic) that permits the processing of data or signals. The control device can comprise, for example, one or more than one processor.

The term “image” as used herein can be any type of digital image data which can represent a visual representation, such as a digital RGB image, a digital RGB-D image, a binary image, a 3D image, a point cloud, a time series, a semantic segmentation image, etc.

The expression that an element, a parameter, etc. “represents” another element, another parameter, etc. can be understood to mean that they are linked with one another, for example, the element and/or the parameter is one (for example, unique, for example, one to one) function of the other element and/or parameter.

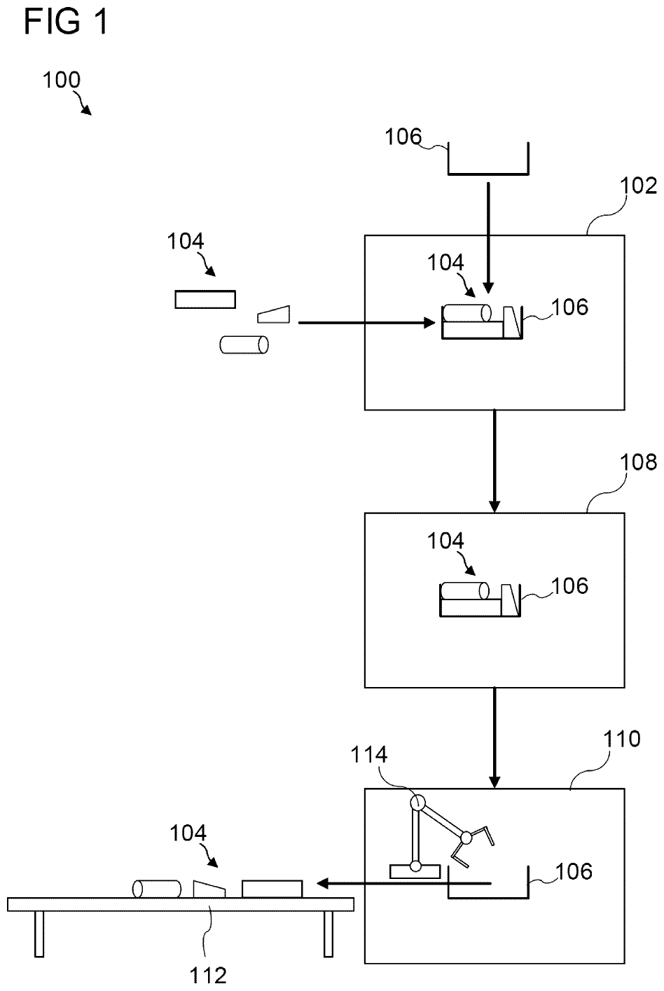

FIG. 1 shows an exemplary warehouse system 100 according to various aspects. The warehouse system 100 can comprise a packing station 102. Multiple objects 104 can be packed in a storage box 106 at the packing station. In some embodiments, the multiple objects 104 can be packed manually by a person into the storage box 106. In other aspects, the packing station 102 can comprise a packing station robotic device configured to pack objects into a storage box 106. During this packing process, a topological arrangement of the objects in the storage box typically results, for example, by arranging them adjacent to one another or one on top of another. The objects can be identical (for example, containing structurally identical fabricates) or different (for example, containing different fabricate versions or fabricate colors), the objects can further be stackable (for example, rectangular cartons) or individual or irregular (for example, blister packages, bulk material).

The storage box 106 can then be transported from the packing station 102 to a storage area 108 (also referred to as a warehouse area), at which the storage box 106 is stored (for example, warehoused). If the multiple objects 104 are required, for example, because they are to be further processed and/or shipped, the storage box 106 can be transported from the storage area 108 to an unpacking station 110. Transportation of a storage box described herein can take place manually (for example, by a person) and/or in an at least partially automated manner (for example, by means of a transport robot).

The unpacking station 110 can comprise a robotic device 114 configured to unpack the storage box 106. For example, the warehouse system 100 can comprise a transport system 112 (such as a conveyor belt) and the robotic device 114 can be configured to pick the multiple objects 104 from the storage box 106 and arrange them on the transport system 112.

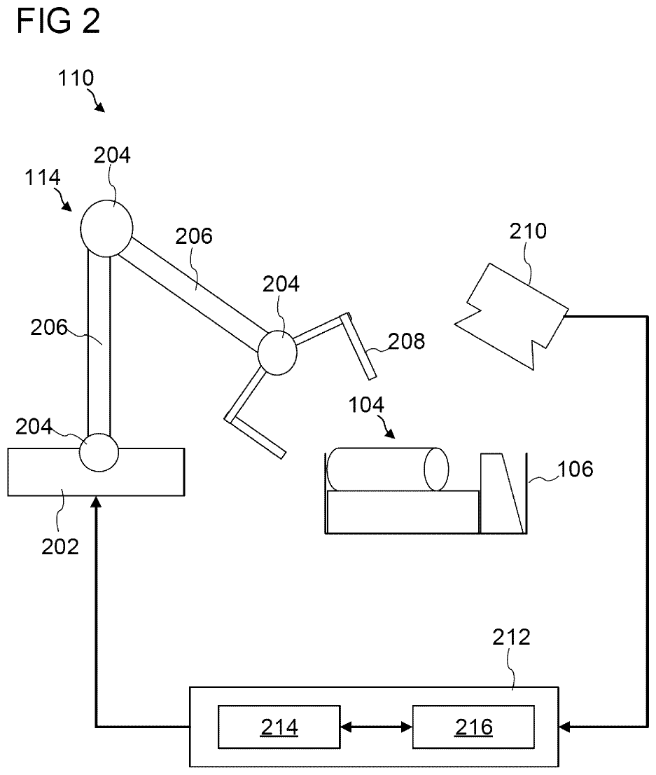

FIG. 2 shows an exemplary embodiment of the unpacking station 110 according to various aspects.

The robotic device 114 can comprise a robotic arm 206 (having one or more connection elements). The robotic device 114 can comprise one or more robotic links 204. A robotic link refers to movable parts of the robotic device 114, the actuation of which enables a physical interaction with the surroundings, for example, to execute a task, for example, to execute one or more skills. The one or more robotic links 204 can provide links between sections of the robotic arm 206. A robotic link can provide a rotational movement and/or a translational movement.

The robotic device 114 can comprise a mount (for example, a pedestal) 202, on which the robotic arm 206 can be fastened.

The robotic device 114 can comprise an end effector 208. The end effector 208 can be configured to enable an object to be picked up. For this purpose, the end effector can comprise one or more than one tool. For example, the end effector 208 can comprise a gripping tool and/or a suction device (for example, a suction cup).

Illustratively, the robotic arm 206 having the end effector 208 can grip objects and move them similarly to a human arm.

It is to be understood that the robotic device 114 is an example and that the unpacking station 110 can also comprise any other type of robotic device capable of picking objects from a storage box. It is also understood that the unpacking station 110 can also comprise more than one robotic device (for example, multiple robotic devices having different end effectors).

The unpacking station 110 can comprise one or more than one data acquisition device. Each data acquisition device can be configured to acquire and provide sensor data. The unpacking station 110 can comprise, for example, a first data acquisition device 210. The first data acquisition device 210 can be configured to acquire first sensor data representing an image of the multiple objects 104 arranged in the storage box. The first data acquisition device 210 can comprise one or more than one sensor configured to acquire the first sensor data. For example, the first data acquisition device 210 can comprise a camera (e.g., standard cameras, digital cameras, video cameras, SLR cameras, infrared cameras, stereo cameras, etc.), a charge-coupled device (CCD), a radar sensor, a LIDAR sensor (light detection and ranging), and/or an ultrasonic sensor.

Sensor data representing an image of the multiple objects 104 arranged in the storage box 106 can comprise, for example, an RGB image, an RGB-D image, or a depth image (also referred to as a D image). A depth image described herein can be any type of image comprising depth information, such as a point cloud provided by a LIDAR sensor and/or a radar sensor and/or an ultrasonic sensor.

The unpacking station 110 (for example, the robotic device 114) can comprise one or more additional data acquisition devices, which can be configured to acquire sensor data characterizing a status of the robotic device 114. For example, the one or more additional data acquisition devices can comprise an imaging sensor, such as a camera (for example, a standard camera, digital camera, an infrared camera, a stereo camera, etc.), a radar sensor, a LIDAR sensor, a position sensor, a speed sensor, an ultrasonic sensor, an acceleration sensor, a pressure sensor, etc. for acquiring sensor data characterizing the robotic device 114.

The unpacking station 110 can comprise a control device 212. The control device 212 can be configured to control the robotic device 114 to unpack the storage box 106. For this purpose, the control device 212 can control, for example, a movement of the robotic arm 206 (for example, by controlling one or more than one robotic link by means of associated positioning links) and picking up (for example, gripping or suctioning on) an object by means of the end effector 208. The control device 212 can comprise one or more than one processor 214. The control device 212 can comprise a memory device (abbreviated: memory) 216. The memory 216 can store code and data (for example, comprising a robot control model), on the basis of which the processor 214 controls the robotic device 114.

A processor described herein can comprise respective hardware-based processing units. For example, a processor can comprise a microprocessor, preprocessors (such as an image preprocessor), graphics processors, a central processing unit (CPU), assistance circuits, digital signal processors, integrated circuits, memories, or other types of devices which are capable of executing applications and for image processing and analysis. In various aspects, a processor can comprise any type of single core or multicore processor, microcontroller for mobile devices, central processing unit, etc. These processor types can each comprise multiple processing units having local memory and command sets.

The first data acquisition device 210 can be configured to transmit the acquired first sensor data to the control device 212. The control device 212 can be configured to control the robotic device 114 using the first sensor data acquired by the first data acquisition device 210.

Various aspects relate to a control of the robotic device 114 for unpacking the storage box 106 (also referred to as a storage box). Unpacking the storage box 106 can comprise multiple objects 104 being picked in succession from the storage box 106. In this case, an object can be picked in that this object is picked up, subsequently moved, and then deposited at a position outside the storage box 106. The picking up of an object can depend on one or more tools of the end effector 208. If the end effector 208 comprises a gripping tool, picking up an object can thus be gripping of the object. If the end effector 208 comprises a suction tool, picking up an object can thus be suctioning on the object. This applies accordingly to packing of the storage box 106 at the packing station 102, if one (or more than one) packing station robotic device is used thereon. The packing station robotic device can be configured as described above for the robotic device 114. Packing of the storage box 106 can comprise the multiple objects 104 being deposited in succession in the storage box 106. In this case, an object can be picked up, subsequently moved, and then deposited in the storage box 106.

The transmission of data (e.g., sensor data, control instructions, etc.) described herein can be carried out by means of a network which connects the components to one another in a wired and/or wireless manner. In the case of a wireless network, each device described herein (e.g., the control device 212, the first data acquisition device 210, and/or the robotic device 114, etc.) can comprise in each case a corresponding communication interface (for example, comprising a transmitter and receiver). In various aspects, a communication interface can be configured to transmit and receive data according to multiple radio communication technologies.

Various sequences of the unpacking and packing of the storage box 106 will be explained hereinafter. It is to be understood that the control device 212 can be configured (for example, using the processor 214) to implement these sequences.

During the packing of the storage box 106, first box information can be generated for the storage box 106. The first box information can then be stored in the memory 216 together with the identification information for identifying the storage box 106. The identification of a storage box can comprise any suitable identification principle, such as a barcode, a quick response (QR) code, a transponder, etc.

The first box information can specify, for example, which multiple objects 104 are arranged in the storage box 106. For example, the first box information can specify an object type (for example, specified by an object identification, abbreviated object ID) for each object of the multiple objects. The first box information can further specify in which arrangement the multiple objects 104 are located. The arrangement can comprise a chronological arrangement and/or a spatial arrangement. The chronological arrangement can comprise an order in which the multiple objects 104 were arranged in the storage box 106. The spatial arrangement can be the topological location of the multiple objects 104. The first box information can therefore specify the order in which the multiple objects 104 were arranged in the storage box 106, and/or their topological location (for example, absolute location in the storage box and/or relative location in relation to one or more other objects). When the order of the multiple objects 104 is discussed hereinafter, it is understood that this can be the chronological arrangement. When the respective position and/or pose of the multiple objects 104 is discussed hereinafter, it is understood that this can be the spatial arrangement.

In some embodiments, the packing station 102 can be a manual packing station at which a person packs the multiple objects 104 in succession into the storage box 106. In this case, the person can scan a respective object of the multiple objects 104 by means of a scanning device (for example, a barcode of the object) and then place it in the storage box 106. Illustratively, the control device 212 can receive in succession object identification data associated with one object of the multiple objects 104, which data represent an identification of the object. The order in which the object identification data of the multiple objects are received can then correspond to the order in which the multiple objects 104 are/were arranged in the storage box 106. The first box information can then comprise the object identification data of the multiple objects 104 in addition to the order.

The manual packing station can optionally comprise a packing station data acquisition device. The packing station data acquisition device can be configured to acquire packing station sensor data which represent an image of the one or more objects arranged in the storage box. For example, respective packing station sensor data can be acquired by means of the packing station data acquisition device after a respective object of the multiple objects 104 has been arranged in the storage box 106. The packing station data acquisition device can be configured as described above for the first data acquisition device. This enables the control device 212 to be able to determine position data and/or pose data on the basis of the packing station sensor data for each object of the multiple objects 104. The position data can specify a position of the respective object in the storage box 106. The pose data can specify a pose of the respective object in the storage box 106. In this case, the first box information can comprise, in addition to which multiple objects 104 are arranged in the storage box 106 and in which order, the position data and/or pose data for each object of the multiple objects 104. Illustratively, the arrangement of the multiple objects can comprise the order in which the multiple objects were arranged in the storage box 106 (as the chronological arrangement) and the position data and/or pose data of the multiple objects (as the spatial arrangement).

When reference is made herein to the first box information comprising a respective position and/or pose of the multiple objects 104, it is understood that the packing station can in this case comprise the packing station data acquisition device.

Illustratively, the pose data can specify how (for example, oriented) the respective object is arranged in the storage box 106 (for example, which side of the object is directed upward).

In other embodiments, the packing station 102 can be an at least partially automated packing station. In this case, the packing station 102 can comprise the packing station robotic device in addition to the packing station data acquisition device. The packing control instructions for controlling the packing station robotic device during the packing of the storage box 106 can specify for each object at which position and/or with which pose the object is/was arranged in the storage box 106. Therefore, the first box information can in this case comprise the respective position and/or pose for each object of the multiple objects 104.

Various robot control models can be used to generate control instructions for packing a storage box, which reduce (for example, minimize), for example, a packing time duration (thus a time duration required for packing). According to various aspects, the control device 212 can be configured to generate the packing control instructions for controlling the packing station robotic device for packing the storage box 106 (for example, using a robot control model) in such a way that not only the (predicted) packing time duration, but also the (predicted) unpacking time duration is reduced (for example, minimized). In this case, the control device 212 can store a packing plan (which also represents an unpacking plan) as part of the first box information in the memory 216. In this way, an expenditure (for example, computing effort and/or energy consumption) can be reduced, since an order for removing the objects does not have to be determined again during the unpacking.

The control device 212 (for example, the one or more than one processor 214) can be configured to determine stacking information using the respective position and/or pose of the multiple objects 104, which indicates how the multiple objects 104 are stacked on each other in the storage box. The stacking information can be determined using the dimensions of the respective object. The dimensions (e.g., width, height, depth, shape, extension, etc.) of an object can be represented, for example, by the first box information (since this specifies which multiple objects 104 are arranged in the storage box 106). Optionally, the dimensions can also be determined from the packing station sensor data.

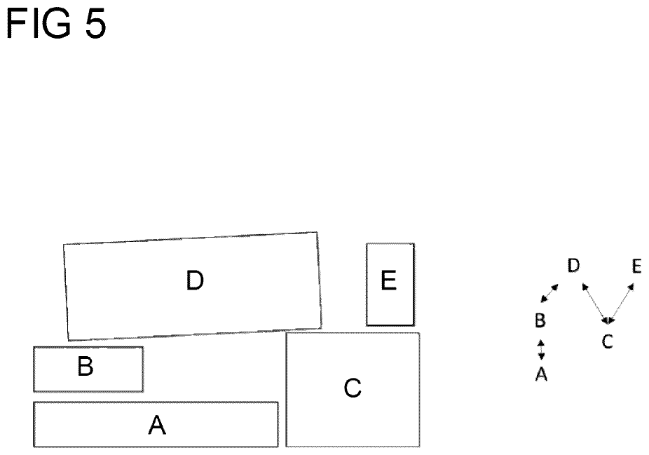

An exemplary stack of five objects A, B, C, D, E is shown for illustration in FIG. 5. According to various aspects, the first box information can comprise the stacking information. The stacking information can comprise, for example, a double linked list, a graph, and/or a tree structure. Illustratively, the stacking information can indicate how the multiple objects 104 are stacked on each other in the storage box 106.

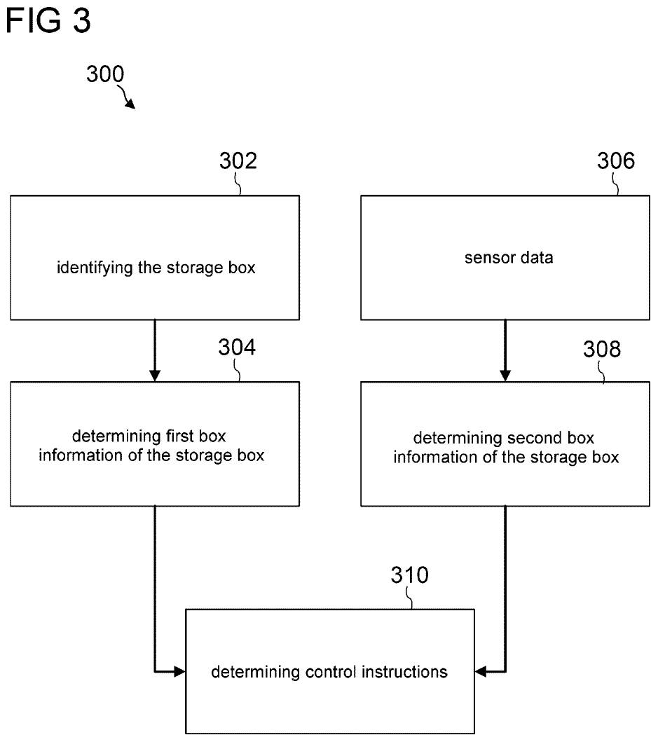

FIG. 3 shows a flow chart 300 for unpacking the storage box 106 according to various aspects.

In 302, identification data can be received which represent an identification of the storage box. As described above, the identification data can be, for example, a barcode, a QR code, a transponder, etc. The identification of the storage box 106 can be performed in any way which enables a unique identification of a storage box from a plurality of storage boxes.

In 304, the first box information (for example, stored in the memory 216) can be determined for the (identified) storage box 106.

In 306, the control device 212 can receive sensor data from the first data acquisition device 210, which represent an image of the multiple objects 104 arranged in the storage box 106.

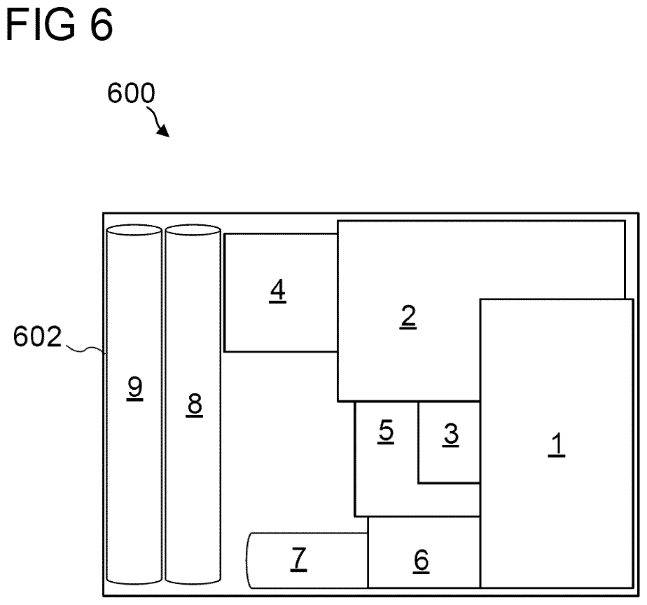

In 308, the control device 212 can perform an object recognition to recognize the multiple objects 104 arranged in the storage box 106. For this purpose, the control device 212 can determine second box information which indicates (for example, comprises a prediction about) which objects are arranged in the storage box 106. FIG. 6 shows second box information as an exemplary image 600 of multiple objects arranged in a storage box 602. Further, numbers are indicated in the image which indicate an order determined by way of example, in which the multiple objects are to be picked from the storage box. This exemplary image illustrates the importance of the order in which the objects are picked from the storage box. For example, if object 2 were picked before object 1, due to the overlaps of these objects, it can occur that (for example, if the overlap of object 2 with object 1 was not correctly identified) both articles are gripped simultaneously or object 1 is pushed out of the storage box. This applies accordingly to objects 3 and 4, which are both arranged under object 2.

The object recognition can be any type of object recognition by means of which objects in a storage box can be recognized. For example, the object recognition can comprise a (for example, semantic) object segmentation. The control device 212 can be configured to implement a model (for example, a machine learning model) for object recognition.

In 310, the control device 212 can compare the first box information to the second box information and generate control instructions for controlling the robotic device 114 based thereon.

If the control instructions were generated exclusively using the second box information, some objects of the multiple objects 104 could be incorrectly recognized. However, if the first box information is additionally used, which explicitly indicates which multiple objects 104 are arranged in the storage box 106 (and optionally further the respective position and/or pose thereof), the recognition rate can be significantly increased.

Due to the increased recognition rate, a number of human interventions can also be reduced and the throughput of the warehouse system can be increased.

Since the first box information already indicates which multiple objects 104 are arranged in the storage box 106, each object of the multiple objects 104 can be assigned to precisely one object of the second box information. If two or more than two classes (which represent the object type) are determined for an object, for example, during the classification of the sensor data (to determine the second box information), the correct class can be selected using the first box information.

The first box information can also comprise data which it was not possible to acquire by means of an object recognition function to determine the second box information, such as a respective material (for example, whether a material is glass or plastic) of the multiple objects 104.

The correct object recognition is necessary to determine correct gripping data, according to which the robotic device 114 grips the objects.

In some aspects, the control device 212 can determine the control instructions using the stacking information. The control device 212 can, for example, using the respective object type of the multiple objects 104 and the stacking information, determine whether the picking of one or more than one object can damage one or more than one other object (for example, since the one or more than one other object is easily breakable). Therefore, in this case damage to objects during unpacking of a storage box can be reduced. With reference to the exemplary image of FIG. 6, without the stacking information the result could be that the objects 8 and 9 can be picked, since they do not have overlaps with other objects. However, it can result from the stacking information that picking the object 8 and/or the object 9 can have the result that the stack made up of the multiple objects collapses.

According to various aspects, the control device 212 can further be configured to compare the packing station sensor data, which represent one or more than one image of the objects arranged in the storage box at the packing station 102, with the sensor data which represent one or more than one image of the objects arranged in the storage box at the unpacking station 110, in order to determine whether one or more than one object of the multiple objects 104 is damaged.

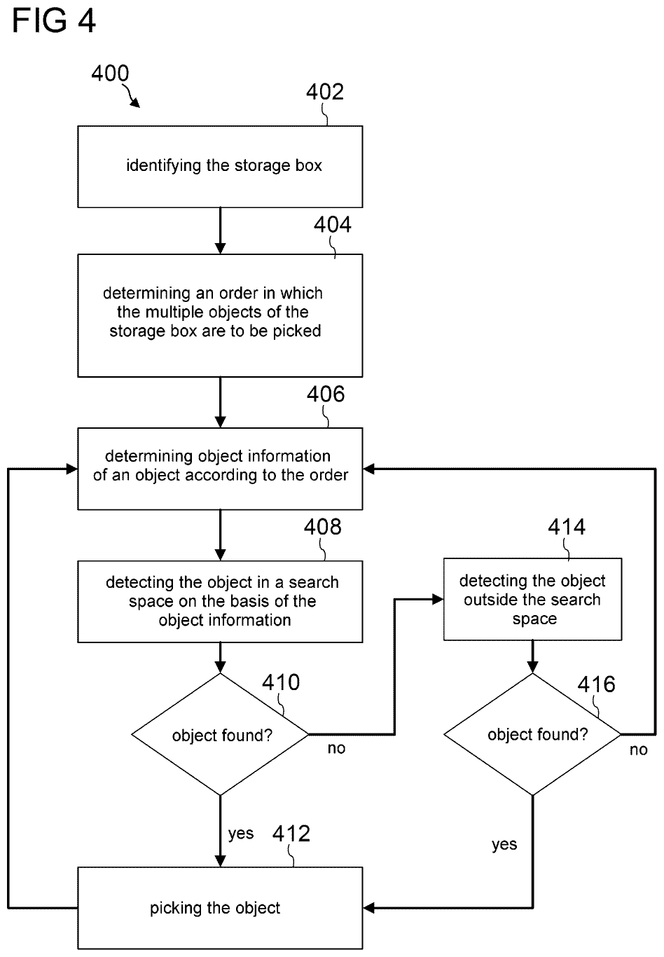

FIG. 4 shows a flow chart 400 for picking at least one object from a storage box using position data according to various aspects.

In 402, the identification of the storage box 106 takes place as described above. The control device 212 can then determine the first box information for the (identified) storage box 106.

In 404, the storage device 212 can determine an order in which the multiple objects 104 are to be picked from the storage box 106. For example, the order in which the multiple objects 104 are to be picked from the storage box 106 can be opposite to the order in which the multiple objects 104 were arranged in the storage box 106.

In 406, object information can be determined of the object to be picked next according to the order in which the multiple objects 104 are to be picked from the storage box 106. The first box information can comprise and/or represent the object information. In this example, the object information can comprise at least one object type of the respective object and a position of the respective object (and optionally further a pose of the respective object).

The control device 212 can receive sensor data from the first data acquisition device, which represent an image of the one or more objects arranged (not yet picked) at this time (thus before the picking of the object to be picked next) in the storage box 106.

The control device 212 can be configured to determine a search space for searching for the object in the image using the position of the object to be picked next. The search space can comprise a detail of the image. In 408, the object to be picked next can be searched for in the search space (optionally using the pose of the object). For this purpose, the object recognition function described herein can be applied to the sensor data.

If an object is searched for in a search space (as a subspace of the entire storage box 106), the number of incorrect recognitions can be reduced (since only the objects in this search space are taken into account). The use of the search space also enables objects which have the same object type (but are arranged at different positions in the storage box 106) to be distinguished.

If the object to be picked next is found in the search space (“yes” in 410), the control device 212 generates (in 412) the control instructions for picking the object.

If the object to be picked next is not found in the search space (“no” in 410), the control device 212 can determine another search space which is larger than the search space (for example, the entire storage box 106), and/or can optionally search for another pose. In 414, the object to be picked next can be searched for in the other search space (optionally using the pose of the object).

If the object to be picked next is found in the other search space (“yes” in 416), the control device 212 generates (in 412) the control instructions for picking the object. If the object to be picked next is not found in the search space (“no” in 414), the control device 212 can continue with the following object to be picked (and optionally store the information obtained with respect to the object that was not found in the memory 216).

Due to the use of the search space, the computational expenditure for finding an object can be reduced (since it is not necessary to search through the entire image for each object).

According to various aspects, the transport of the storage box 106 from the packing station 102 (by means of the storage area 108) to the unpacking station 110 is taken into account.

For this purpose, the first box information can further comprise transport data which represent how the storage box 106 was transported from the packing station 102 to the unpacking station 110.

For example, the storage box 106 can have been moved by one or more than one transport robot and each transport robot can acquire acceleration data during the transportation of the storage box 106. The transport data can comprise these acceleration data from each transport robot.

For example, the storage box 106 can comprise an acceleration sensor, which acquires acceleration data of the storage box 106, and the transport data can comprise these acceleration data.

The control device 212 (for example, the one or more than one processor 214) can be configured to implement a movement model. The movement model can be configured to output, in reaction to an input of the object information (e.g., object type, object shape, position, pose, etc.) of each object of the multiple objects 104 and the transport data (and optionally further the stacking information) into the movement model, adapted position data and/or adapted pose data for each object of the multiple objects 104. Illustratively, it can be predicted by means of the movement model how the multiple objects 104 have moved as a result of the transport in the transport box 106.

These adapted position data and/or adapted pose data can then be used, for example, as the foundation for determining the search space in order to search for the respective object to be picked in this search space (in 408).

Optionally, the movement model can have been trained online on the basis of the information about which position and/or with which pose a respective object is actually arranged in the storage box 106. The difference between the position and/or pose of an object in the storage box 106 at the packing station and the position and/or pose of the object upon picking at the unpacking station 110 thus supplies information on the movement of the object as a result of the transport. It can also be concluded, for example, if many objects have moved significantly, that the transport process should be reworked.

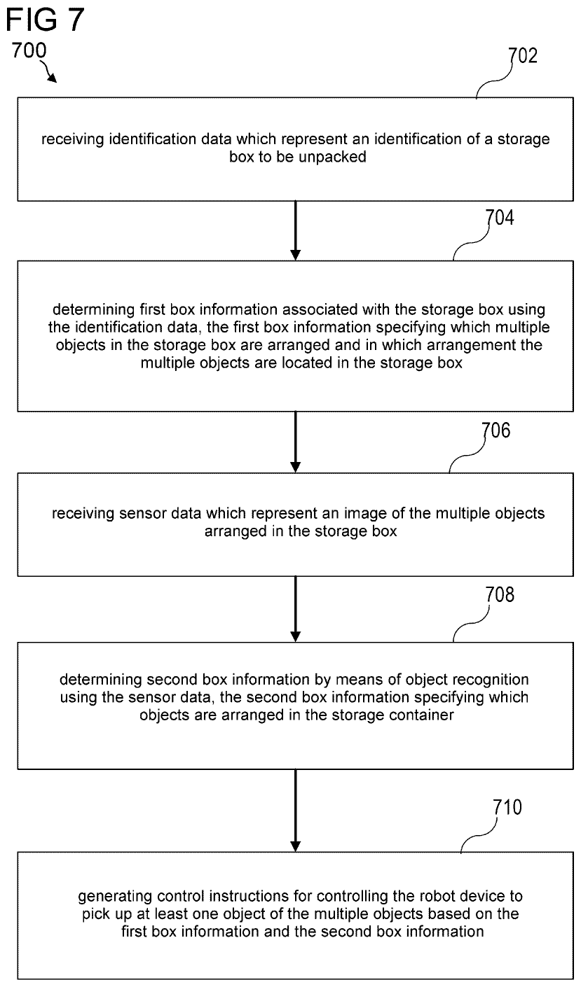

FIG. 7 shows a flow chart of a method for controlling a robotic device for picking at least one object from a storage box according to various aspects.

The method 700 can comprise (in 702) receiving identification data which represent an identification of a storage box to be unpacked.

The method 700 can comprise (in 704) determining first box information associated with the storage box (for example, stored in a storage device) using the identification data. The first box information can indicate which multiple objects are arranged in the storage box and in which order the multiple objects were arranged in the storage box.

The method 700 can comprise (in 706) receiving (for example, from a sensor, such as an imaging unit) sensor data which represent an image of the multiple objects arranged in the storage box.

The method 700 can comprise (in 708) determining second box information by means of an object recognition function using the sensor data. The second box information can indicate (for example, comprise a prediction about) which objects are arranged in the storage box.

The method 700 can comprise (in 710) generating control instructions for controlling the robotic device for picking up at least one object of the multiple objects based on the first box information and the second box information.

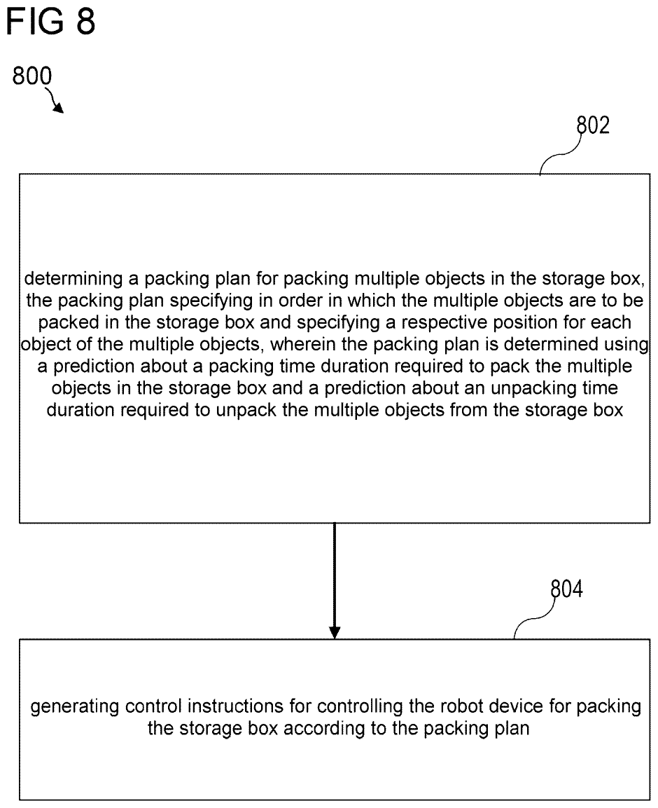

FIG. 8 shows a flow chart of a method 800 for controlling a robotic device for packing a storage box according to various aspects.

The method 800 can comprise (in 802) determining a packing plan for packing multiple objects in the storage box. The packing plan can indicate an order in which the multiple objects are to be packed in the storage box and a respective position (and optionally further a pose) for each object of the multiple objects. The packing plan can have been determined using a prediction about a packing time duration required for packing the multiple objects in the storage box and a prediction about an unpacking time duration required for unpacking the multiple objects from the storage box.

The method 800 can comprise (in 804) generating control instructions for controlling the robotic device to pack the storage box according to the packing plan.

Various examples are provided hereinafter, which describe one or more aspects of the control device 212 and the method (for example, the method 700 and/or the method 800). It is understood that aspects which are described with reference to the control device 212 can also apply to the methods and vice versa.

Example 1 is a control device for controlling a robotic device for picking at least one object from a storage box, the control device comprising: a memory device which stores, for each storage box of a plurality of storage boxes, respectively associated first box information indicating which multiple objects are arranged in the storage box and in which arrangement (for example, chronological and/or spatial) the multiple objects are in the storage box; and a processor, configured to: receive identification data representing an identification of a storage box; determine the first box information associated with the storage box using the identification data; receive sensor data representing an image of the multiple objects arranged in the storage box; determine, via object recognition using the sensor data, second box information indicating (for example, comprising a prediction about) which objects are arranged in the storage box; and generate control instructions for controlling the robotic device to pick up at least one object of the multiple objects based on the first box information associated with the storage box and the second box information.

Example 2 is configured according to example 1, wherein the processor is configured to determine the respectively associated first box information of a respective storage box of the plurality of storage boxes in that the processor for each object of the multiple objects iteratively: receives object identification data associated with the object before the object is arranged in the storage box, the object identification data representing an identification of the object; stores the first box information associated with the object in the memory device, wherein the first box information comprises the object identification data; and wherein the processor is configured to store the first box information in the memory device, wherein the arrangement of the multiple objects in the storage box comprises an order (as a chronological arrangement) corresponding to the order in which the processor receives the object identification data of the multiple objects.

Example 3 is configured according to example 2, wherein the processor is further configured to iteratively for each object of the multiple objects: receive packing station sensor data (for example, from a packing station sensor, such as a packing station imaging unit) associated with the object, the packing station sensor data representing an image of the one or more than one object arranged in the storage box after the object has been placed in the storage box; using the packing station sensor data, determine position data associated with the object, the position data indicating a position of the object in the storage box; wherein the arrangement comprises the position data (as a spatial arrangement); wherein the processor is configured to generate the control instructions using the position data.

Example 4 is configured according to example 3, wherein the processor is further configured to iteratively for each object of the multiple objects: determine pose data associated with the object using the packing station sensor data, which indicate a pose (for example, orientation) of the object in the storage box; wherein the arrangement comprises the pose data (as a spatial arrangement); wherein the processor is configured to generate the control instructions using the pose data.

Example 5 is configured according to example 3 or 4, wherein the processor is configured to: determine stacking information using the arrangement (for example, the order in which the multiple objects were arranged in the storage box and the position data of the multiple objects (and optionally further the pose data of the multiple objects)), the stacking information indicating how the multiple objects are stacked on each other in the storage box; and generate the control instructions using the stacking information.

Example 6 is configured according to any one of examples 1 to 5, wherein the processor is configured to: determine a packing plan for packing the multiple objects into the storage box, wherein the packing plan indicates an order in which the multiple objects are to be packed into the storage box and a respective position (and optionally further a pose) for each object of the multiple objects; and wherein a prediction of a packing time duration required to pack the multiple objects into the storage box and a prediction of an unpacking time duration required to unpack the multiple objects from the storage box are taken into account when determining the packing plan.

Example 7 is configured according to example 6, wherein the processor is configured to: store the packing plan in the memory device; and generate the control instructions for controlling the robotic device using the packing plan.

Example 8 is configured according to any one of examples 1 to 7, wherein the processor is configured to determine, based on first box information associated with the storage box and second box information, whether one or more than one object of the multiple objects is damaged.

Example 9 is configured according to any one of examples 1 to 8, wherein the second box information comprises multiple predicted objects; and wherein the processor is configured to assign an object of the multiple objects to each predicted object of the multiple predicted objects.

Example 10 is configured according to example 9, wherein the arrangement further comprises respective position data (as a spatial arrangement) for each object of the multiple objects, the respective position data indicating a position of the object in the storage box; wherein the second box information associated with the respective storage box further comprises respective predicted position data for each predicted object of the multiple predicted objects, the respective predicted position data indicating a predicted position of the predicted object in the storage box; and wherein the processor is configured to assign to each predicted object of the multiple predicted objects the object of the multiple objects using a comparison of the position data of the multiple objects to the predicted position data of the multiple predicted objects.

Example 11 is configured according to example 10, wherein the arrangement further comprises respective pose data (as a spatial arrangement) for each object of the multiple objects, the pose data indicating a pose of the object in the storage box; wherein the second box information associated with the respective storage box further comprises respective predicted pose data for each predicted object of the multiple predicted objects, the respective predicted pose data indicating a predicted pose of the predicted object in the storage box; wherein the processor is configured to assign to each predicted object of the multiple predicted objects the object of the multiple objects using a comparison of the pose data of the multiple objects to the predicted pose data of the multiple predicted objects.

Example 12 is configured according to example 10 or 11, wherein the storage device further stores transport data representing how the storage box was transported from a packing station at which the multiple objects were packed in the storage box to an unpacking station comprising the robotic device; wherein the processor is configured to compare the position data of the multiple objects to the predicted position data of the multiple predicted objects, in that the processor determines adapted position data (which take into account a position change of the object as a result of the transport) for each object of the multiple objects using the position data and the transport data, and compares the adapted position data of the multiple objects to the predicted position data of the multiple predicted objects.

Example 13 is configured according to examples 11 and 12, wherein the processor is configured to compare the pose data of the multiple objects to the predicted pose data of the multiple predicted objects in that the processor determines adapted pose data (which take into account a pose change of the object as a result of the transport) for each object of the multiple objects using the pose data and the transport data, and compares the adapted pose data of the multiple objects to the predicted pose data of the multiple predicted objects.

Example 14 is configured according to any one of examples 1 to 13, wherein the processor is configured to generate the control instructions using the arrangement in which the multiple objects are located in the storage box.

Example 15 is configured according to example 14, wherein the control instructions indicate an order in which the multiple objects are to be picked from the storage box, wherein the order is opposite to an order indicated by the arrangement in which the multiple objects were arranged in the storage box.

Example 16 is configured according to any one of examples 1 to 15, wherein the processor is configured to control the robotic device to deposit the (picked up) at least one object on a conveyor belt and/or in another storage box.

Example 17 is a system (for example, a warehouse system), comprising: a control device according to any one of examples 1 to 16; and an unpacking station for unpacking the storage box, wherein the unpacking station comprises a sensor for acquiring the sensor data (for example, an imaging unit) and the robotic device.

Example 18 is configured according to example 17, further comprising: a packing station for packing objects into a storage box, wherein the packing station comprises a packing station sensor for acquiring one or more objects arranged in the storage box.

Example 19 is configured according to example 17 or 18, wherein the packing station further comprises a packing station robotic device configured to pick up an object and to deposit the object in the storage box.

Example 20 is a method for controlling a robotic device for picking at least one object from a storage box, the method comprising: receiving identification data representing an identification of a storage box to be unpacked; determining first box information associated with the storage box (for example, stored in a memory device) using the identification data, wherein the first box information indicates which multiple objects are arranged in the storage box and in which (for example chronological and/or spatial) arrangement the multiple objects are in the storage box; receiving (for example, from a sensor, such as an imaging unit) sensor data representing an image of the multiple objects arranged in the storage box; determining second box information via object recognition using the sensor data, wherein the second box information indicates (for example, comprise a prediction about) which objects are arranged in the storage box; generating control instructions for controlling the robotic device to pick up at least one object of the multiple objects based on the first box information and the second box information.

Example 21 is the method according to example 20, further comprising: determining the respectively associated first box information of a respective storage box of the plurality of storage boxes by, for each object of the multiple objects, iteratively: receiving object identification data associated with the object before the object is arranged in the storage box, the object identification data representing an identification of the object, wherein the first box information comprises the object identification data; wherein the arrangement of the multiple objects in the storage box comprises an order (as a chronological arrangement) corresponding to the order in which the object identification data of the multiple objects are received.

Example 22 is configured according to example 21, wherein determining the first box information respectively assigned to the respective storage box of the plurality of storage boxes further comprises: for each object of the multiple objects iteratively: receiving (for example, from a packing station sensor such as a packing station imaging unit) packing station sensor data associated with the object, the packing station sensor data representing an image of the one or more than one object arranged in the storage box after the object has been arranged in the storage box; determining position data associated with the object using the packing station sensor data, the position data indicating a position of the object in the storage box, wherein the arrangement comprises the position data (as a spatial arrangement); wherein the control instructions are generated using the position data.

Example 23 is configured according to example 22, wherein determining the first box information respectively assigned to the respective storage box of the plurality of storage boxes further comprises iteratively: for each object of the multiple objects: determining pose data associated with the object using the packing station sensor data, which pose data indicate a pose (for example, orientation) of the object in the storage box, wherein the arrangement comprises the pose data (as a spatial arrangement); wherein the control instructions are generated using the pose data.

Example 24 is the method according to example 22 or 23, further comprising: determining stacking information using the arrangement (for example, the order in which the multiple objects were arranged in the storage box, the position data of the multiple objects (and optionally further the pose data of the multiple objects)), the stacking information indicating how the multiple objects are stacked on each other in the storage box; wherein the control instructions are generated using the stacking information.

Example 25 is the method according to any one of examples 20 to 24, further comprising: determining a packing plan for packing the multiple objects in the storage box, wherein the packing plan indicates an order in which the multiple objects are to be packed in the storage box, and a respective position (and optionally further a pose) for each object of the multiple objects; wherein when determining the packing plan, a prediction about a packing time duration required for packing the multiple objects in the storage box and a prediction about an unpacking time duration required for unpacking the multiple objects from the storage box are taken into account; and optionally packing the multiple objects in the storage box according to the packing plan.

Example 26 is configured according to example 25, wherein the control instructions for controlling the robotic device are generated using the packing plan.

Example 27 is the method according to any one of examples 20 to 26, further comprising: determining whether one or more than one object of the multiple objects is damaged on the basis of the first box information and the second box information associated with the storage box.

Example 28 is configured according to any one of examples 20 to 27, wherein the second box information comprises multiple predicted objects; wherein the method comprises assigning one object of the multiple objects to each predicted object of the multiple predicted objects.

Example 29 is configured according to example 28, wherein the arrangement further comprises respective position data (as a spatial arrangement) for each object of the multiple objects, the respective position data indicating a position of the object in the storage box; wherein the second box information associated with the respective storage box further comprises respective predicted position data for each predicted object of the multiple predicted objects, the respective predicted position data indicating a predicted position of the predicted object in the storage box; wherein the method comprises assigning the object of the multiple objects to each predicted object of the multiple predicted objects using a comparison of the position data of the multiple objects to the predicted position data of the multiple predicted objects.

Example 30 is configured according to example 29, wherein the arrangement further comprises respective pose data (as a spatial arrangement) for each object of the multiple objects, the respective pose data indicating a pose of the object in the storage box; wherein the second box information associated with the respective storage box further comprises respective predicted pose data for each predicted object of the multiple predicted objects, the respective predicted pose data indicating a predicted pose of the predicted object in the storage box; wherein the method comprises assigning the object of the multiple objects to each predicted object of the multiple predicted objects using a comparison of the pose data of the multiple objects to the predicted pose data of the multiple predicted objects.

Example 31 is the method according to example 29 or 30, further comprising: receiving transport data representing how the storage box was transported from a packing station at which the multiple objects were packed in the storage box to an unpacking station comprising the robotic device; wherein comparing the position data of the multiple objects to the predicted position data of the multiple predicted objects comprises: determining for each object of the multiple objects adapted position data (which take into account a position change of the object as a result of the transport) using the position data and the transport data, and comparing the adapted position data of the multiple objects to the predicted position data of the multiple predicted objects.

Example 32 is configured according to examples 30 and 31, wherein comparing the pose data of the multiple objects to the predicted pose data of the multiple predicted objects comprises: determining for each object of the multiple objects adapted pose data (which take into account a position change of the object as a result of the transport) using the pose data and the transport data, and comparing the adapted pose data of the multiple objects to the predicted pose data of the multiple predicted objects.

Example 33 is configured according to any one of examples 20 to 32, wherein the control instructions are generated using the arrangement in which the multiple objects are located in the storage box.

Example 34 is configured according to example 33, wherein the control instructions indicate an order in which the multiple objects are to be picked from the storage box, wherein the order is opposite to an order indicated by the arrangement in which the multiple objects were arranged in the storage box.

Example 35 is the method according to any one of examples 20 to 34, further comprising: controlling the robotic device to deposit the (picked up) at least one object on a conveyor belt and/or in another storage box.

Example 36 is a method for controlling a robotic device for picking at least one object from a storage box, the method comprising: receiving identification data representing an identification of a storage box to be unpacked; determining first box information (for example, stored in a memory device) associated with the storage box using the identification data, wherein the first box information indicates which multiple objects are arranged in the storage box and represent the order in which the multiple objects are to be picked from the storage box; for a respective object of the multiple objects according to the order in which the multiple objects are to be picked from the storage box, iteratively: receiving (for example, from a sensor, such as an imaging unit) sensor data representing an image of the one or more objects arranged (not yet picked) in the storage box; determining whether the image shows the respective object using the sensor data; if it is determined that the image shows the respective object, generating control instructions for controlling the robotic device to pick the respective object from the storage box.

Example 37 is the method according to example 36, further comprising: if it is determined that the image does not show the respective object, continuing with the following object of the multiple objects according to the order.

Example 38 is configured according to example 36 or 37, wherein the first box information comprises respective position data for each object of the multiple objects, which respective position data indicate a position of the object in the storage box; wherein determining whether the image shows the respective object comprises: determining, using the position data of the respective object, a search space for searching for the respective object in the image; and determining whether the image shows the respective object in the search space.

Example 39 is configured according to example 38, wherein determining whether the image shows the respective object further comprises: if it is determined that the image does not show the respective object in the search space, determining an adapted search space comprising a larger section of the image than the search space; and determining whether the image shows the respective object in the adapted search space.

Example 40 is configured according to example 38 or 39, wherein the first box information comprises respective pose data for each object of the multiple objects, which respective pose data indicate a pose of the object in the storage box; and wherein the search space is determined using the pose data.

Example 41 is the method according to any one of examples 38 to 40, further comprising: receiving transport data representing how the storage box was transported from a packing station at which the multiple objects were packed in the storage box to an unpacking station comprising the robotic device; wherein the search space is determined using the transport data.

Example 42 is a method for controlling a robotic device for packing a storage box, the method comprising: determining a packing plan for packing multiple objects in the storage box, wherein the packing plan indicates an order in which the multiple objects are to be packed into the storage box and a respective position (and optionally further a pose) for each object of the multiple objects; and generating control instructions for controlling the robotic device for packing the storage box according to the packing plan; wherein the packing plan is determined using a prediction about a packing time duration required for packing the multiple objects in the storage box and a prediction about an unpacking time duration required for unpacking the multiple objects from the storage box.

Example 43 is configured according to example 42, wherein the packing plan is determined such that the prediction about the packing time duration required for packing the multiple objects in the storage box and the unpacking time duration required for unpacking the multiple objects from the storage box are reduced (for example, minimized).

Example 44 is the method according to example 42 or 43, further comprising: controlling the robotic device for packing the multiple objects in succession into the storage box according to the packing plan; after a respective object of the multiple objects has been packed in the storage box, acquiring (for example, by means of a packing station sensor, such as a packing station imaging unit) packing station sensor data associated with the object, which packing station sensor data represent an image of the one or more objects arranged at this time in the storage box.

Example 45 is a (for example, non-transitory) computer-readable medium (e.g., a computer program product, a nonvolatile memory medium, a non-transitory memory medium, or a nonvolatile memory medium), which stores instructions which, upon execution by a processor, cause the processor to control a device in order to perform a method according to any one of examples 20 to 44.

Example 46 is one or more than one means for performing the method according to any one of examples 20 to 44.

In the above description and the associated figures, the components of electronic devices are sometimes shown as separate elements. In this regard, it is understood that discrete elements can be combined or integrated to form a single element. This includes the combination of two or more circuits to form a single circuit, the installation of two or more circuits on a common chip or chassis to form an integrated element, the execution of discrete software components on a common processor core, etc. Vice versa, it is understood that a single element can be divided into two or more discrete elements, such as the division of a single circuit into two or more separate circuits, the division of a chip or chassis into discrete elements, which were originally provided thereon, the division of a software component into two or more sections and the execution thereof on a separate processor core, etc.

It is presumed that the implementations of the methods described herein have demonstrative character and can therefore be implemented in a corresponding device. It is also presumed that implementations of the device described herein can be implemented as a corresponding method. It is therefore apparent that a device corresponding to a method described herein can comprise one or more components configured so as to execute each aspect of the corresponding method.

While the invention has been shown and described in particular with reference to specific embodiments, it is understood that various changes of the design can be made without deviating from the scope of the invention as defined by the appended claims. The scope of the invention is therefore defined by the appended claims and all changes which fall in the meaning and the area of an equivalence of the claims are therefore included.

1. A control device for controlling a robotic device for picking at least one object from a storage box, the control device comprising:
a memory device storage, for each storage box of a plurality of storage boxes, respectively associated first box information indicating which multiple objects are arranged in the storage box and in which arrangement the multiple objects are in the storage box; and
a processor, configured to:
receive identification data representing an identification of a storage box;
determine the first box information associated with the storage box using the identification data;
receive sensor data representing an image of the multiple objects arranged in the storage box;
determine, via object recognition using the sensor data, second box information indicating which objects are arranged in the storage box; and
generate control instructions for controlling the robotic device to pick up at least one object of the multiple objects based on the first box information associated with the storage box and the second box information.

2. The control device of claim 1, wherein the processor is configured to determine the respectively associated first box information of a storage box of the plurality of storage boxes in that the processor for each object of the multiple objects iteratively:
receives object identification data associated with the object before the object is arranged in the storage box, the object identification data representing an identification of the object;
stores the first box information associated with the object in the memory device, wherein the first box information comprise the object identification data; and
wherein the processor is configured to store the first box information in the memory device, wherein the arrangement of the multiple objects in the storage box comprises an order corresponding to the order in which the processor receives the object identification data of the multiple objects.

3. The control device of claim 2, wherein the processor configured to iteratively for each object of the multiple objects:
receive packing station sensor data associated with the object, the packing station sensor data representing an image of the one or more objects arranged in the storage box after the object has been placed in the storage box;
using the packing station sensor data, determine position data associated with the object, the position data indicating a position of the object in the storage box;
wherein the arrangement comprises the position data; and
wherein the processor is configured to generate the control instructions using the position data.

4. The control device of claim 3, wherein the processor is configured to:
determine stacking information using the arrangement comprising the position data, the stacking information indicating how the multiple objects are stacked on each other in the storage box; and
generate the control instructions using the stacking information.

5. The control device of claim 4, wherein the processor is further configured to determine, using the arrangement, stacking information indicating how a plurality of objects are stacked on top of each other in the storage box; and to generate the control instructions using the stacking information.

6. The control device of claim 1, wherein the processor is configured to:
determine a packing plan for packing the multiple objects into the storage box, wherein the packing plan indicates an order in which the multiple objects are to be packed into the storage box and a respective position for each object of the multiple objects; and
wherein a prediction of a packing time duration required to pack the multiple objects into the storage box and a prediction of an unpacking time duration required to unpack the multiple objects from the storage box are taken into account when determining the packing plan.

7. The control device of claim 6, wherein the processor is configured to: store the packing plan in the memory device; and generate the control instructions for controlling the robotic device using the packing plan.

8. The control device of claim 1, wherein the processor is configured to determine, based on first box information associated with the storage box and second box information, whether one or more than one object of the multiple objects is damaged.

9. The control device of claim 1,
wherein the second box information comprises multiple predicted objects; and
wherein the processor is configured to assign an object of the multiple objects to each predicted object of the multiple predicted objects.

10. The control device of claim 9,
wherein the arrangement comprises respective position data for each object of the multiple objects, wherein the respective position data indicate a position of the object in the storage box;
wherein the second box information further comprise respective predicted position data for each predicted object of the multiple predicted objects, the respective predicted position data indicated a predicted position of the predicted object in the storage box; and
wherein the processor is configured to assign an object of the multiple objects to each predicted object of the multiple predicted objects using a comparison of the position data with the predicted position data.

11. A system, comprising:
the control device of claim 1; and
an unpacking station for unpacking the storage box, wherein the unpacking station comprises the robotic device and a sensor configured to acquire the sensor data.

12. A method for controlling a robotic device for picking at least one object from a storage box, the method comprising:
receiving identification data representing an identification of a storage box;
determining first box information associated with the storage box using the identification data, wherein the first box information indicate which multiple objects are arranged in the storage box and in which arrangement the multiple objects are in the storage box;
receiving sensor data representing an image of the multiple objects arranged in the storage box;
determining second box information via object recognition using the sensor data, wherein the second box information indicate which objects are arranged in the storage box; and
generating control instructions for controlling the robotic device to pick up at least one object of the multiple objects based on the first box information and the second box information.

13. The method of claim 12, further comprising determining the respectively associated first box information of a storage box of a plurality of storage boxes by, for each object of the multiple objects, iteratively receiving object identification data associated with the object before the object is arranged in the storage box, the object identification data representing an identification of the object; storing the first box information associated with the object in a memory device, wherein the first box information comprise the object identification data; and storing the first box information in the memory device, wherein the arrangement of the multiple objects in the storage box comprises an order corresponding to the order in which the object identification data of the multiple objects is received.

14. The method of claim 13, further comprising iteratively:
receiving packing station sensor data associated with the object, the packing station sensor data representing an image of the one or more objects arranged in the storage box after the object has been placed in the storage box;
wherein the arrangement comprises position data indicating a position of the object in the storage box; and
generating the control instructions using the position data.

15. The method of claim 14, further comprising:
determining stacking information using the arrangement comprising the position data, the stacking information indicating how the multiple objects are stacked on each other in the storage box; and
generating the control instructions using the stacking information.

16. The method of claim 15, further comprising determining, using the arrangement, stacking information indicating how a plurality of objects are stacked on top of each other in the storage box; and generating the control instructions using the stacking information.

17. A non-transitory computer-readable medium storing instructions, which, when executed by a processor, cause the processor to:
receive identification data representing an identification of a storage box;
determine first box information associated with the storage box using the identification data, wherein the first box information indicate which multiple objects are arranged in the storage box and in which arrangement the multiple objects are in the storage box;
receive sensor data representing an image of the multiple objects arranged in the storage box;
determine second box information via object recognition using the sensor data, wherein the second box information indicate which objects are arranged in the storage box; and
generate control instructions for controlling a robotic device to pick up at least one object of the multiple objects based on the first box information and the second box information.

18. The non-transitory computer-readable medium of claim 17, wherein the instructions are further configured to cause the processor to determine the respectively associated first box information of a storage box of a plurality of storage boxes by, for each object of the multiple objects, iteratively receiving object identification data associated with the object before the object is arranged in the storage box, the object identification data representing an identification of the object; storing the first box information associated with the object in a memory device, wherein the first box information comprise the object identification data; and storing the first box information in the memory device, wherein the arrangement of the multiple objects in the storage box comprises an order corresponding to the order in which the object identification data of the multiple objects is received.

19. The non-transitory computer-readable medium of claim 18, wherein the instructions are further configured to cause the processor to iteratively:
receive packing station sensor data associated with the object, the packing station sensor data representing an image of the one or more objects arranged in the storage box after the object has been placed in the storage box;
use the packing station sensor data associated with the object, position data indicating a position of the object in the storage box;
wherein the arrangement comprises the position data; and
generate the control instructions using the position data.

20. The non-transitory computer-readable medium of claim 19, wherein the instructions are further configured to cause the processor to:
determine stacking information using the arrangement comprising the position data, the stacking information indicating how the multiple objects are stacked on each other in the storage box; and
generate the control instructions using the stacking information.
